(19) United States
(12) Patent Application Publication
(10) Pub. No.: US 2008/0153971 A1
(43) Pub. Date: Jun. 26, 2008

(54) Solvent sprayable contact adhesive formulations from (S-I/B)x polymers

(75) Inventor: Lydia Ann Salazar, Katy, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: Kraton Polymers U.S. LLC, Houston, TX (US)

(21) Appl. No.: 11/643,225

(22) Filed: Dec. 21, 2006

(51) Int. Cl. C08L 53/00

(52) U.S. Cl. 524/505

(57) ABSTRACT

The invention relates to a solvent sprayable contact adhesive composition comprising (i) one or more styrenic block copolymer compositions, (ii) a tackifying resin, (iii) a solvent and (iv) optionally one or more plasticizers, wherein said styrenic block copolymer composition comprises: a. a tetra-branched block copolymer (IV) represented by the general formula (A-B)₄X; b. a tri-branched block copolymer (III) represented by the general formula (A-B)₃X; c. a di-branched block copolymer (II) represented by the general formula (A-B)₂X; and d. a linear diblock copolymer (I) represented by the general formula A-B; where: i. A represents a polymer block of a mono alkenyl arene; ii. B represents a polymer block of a mixture of isoprene and 1,3-butadiene in a weight ratio of isoprene to butadiene between about 70:30 and 30:70; iii. X represents the residue of a multi-functional coupling agent; iv. the weight percent of A blocks is between about 15% and about 35%; v. the relative amounts of copolymers IV, III, II, and I are from 0 to 20 weight percent IV, from 0 to 80 weight percent II, from 0 to 80 weight percent II and from 10 to 65 weight percent I, where the total of I, II, III and IV equals 100 weight percent.

### BACKGROUND OF THE INVENTION

1. Field of the Invention

This invention relates to a solvent sprayable contact adhesive composition containing a mixture of uncoupled polymer and coupled polymer, where the rubbery mid block is an isoprene/butadiene block.

2. Background of the Art

Adhesive compositions based on styrenic block copolymers as thermoplastic elastomeric components are well known in the art. Styrenic block copolymers (“SBC's”) have a long history of use in adhesives, sealants and coatings. For example, U.S. Pat. No. 3,239,478 (“Harlan”) discloses adhesives comprising unsaturated styrene-isoprene-styrene block copolymers (“SIS”) and styrene-butadiene-styrene block copolymers (“SBS”) in adhesives and sealants. Harlan also broadly discloses adhesives comprising the hydrogenated S-B-S (i.e. “SEBS”) and hydrogenated S-I-S (i.e. “SEPS”) block copolymers with tackifying resins and extender oils for a variety of adhesives and sealants, including pressure sensitive adhesives.

These compositions are for instance used as PSA (pressure sensitive adhesive) for industrial tapes, packaging tapes and labels, and in multipurpose hot-melt adhesive compositions which may be used to bond or construct articles in the manufacture of disposable soft goods, such as diapers, feminine care articles, surgical drapes and the like.

In WO 02/057386 A2, an adhesive composition is described comprising (i) one or more styrenic block copolymers, (ii) a tackifier resin, and (iii) one or more plasticizers, wherein the styrenic block copolymers is of the general structure

A-C-A (1), or

(A-C)ₙ—X (2),

wherein each A independently is a polymer block of an aromatic vinyl compound, and C is a mixed polymer block (B/I) of butadiene (B) and isoprene (I) in a weight ratio B:I in the range of 30:70 to 70:30, and said polymer block C has a glass transition temperature (T_{g}) of at most -50° C. (determined according to ASTM E-1356-98), n is an integer equal to or greater than 2, and X is the residue of a coupling agent, and wherein the tackifier resin is an aromatic hydrocarbon resin. US Published Patent Application 2005/0137312 discloses a mixed mid-block co-polymer that has a radial structure yet features low melt viscosity and good shear properties.

US Published Patent Application 2005/0119403 discloses low viscosity, high solids content coatings based on hydrogenated S-EB-S block copolymers which have a low level of volatile organics compounds (VOC) meeting California VOC regulations and which can be spray applied as a coating on a variety of surfaces.

What is needed is a solvent sprayable adhesive that meets VOC regulations in the vast majority of the states, and also may contain higher amounts of acetone (which is a much less expensive solvent), while providing excellent properties, including short bonding times and faster strength development.

### SUMMARY OF THE INVENTION

The present invention broadly encompasses a solvent sprayable contact adhesive formulation that has superior properties when compared against prior art formulations. The key to the improvement in properties is use of a block copolymer having styrene end blocks, and midblocks containing a random mixture of isoprene and butadiene (hereinafter referred to as “S-I/B-S” block copolymers). As shown in the examples that follow, S-I/B-S contact adhesive formulations have improved performance in lap shear—ash wood to ash wood bonds when compared to similar contact adhesive formulations made with conventional S-I-S or S-B-S block copolymers. In particular, the present invention is a solvent sprayable contact adhesive composition comprising (i) one or more block copolymers, (ii) one or more tackifying resins, (iii) one or more solvents and (iii) optionally, one or more plasticizers, wherein at least one of the block copolymers is a block copolymer composition comprising:
a. a tetra-branched block copolymer (IV) represented by the general formula (A-B)₄X;
b. a tri-branched block copolymer (III) represented by the general formula (A-B)₃X;
c. a di-branched block copolymer (II) represented by the general formula (A-B)₂X; and
d. a linear diblock copolymer (I) represented by the general formula A-B; where:
   i. A represents a polymer block of a mono alkenyl arene;
   ii. B represents a polymer block of a mixture of isoprene and 1,3-butadiene in a weight ratio of isoprene to butadiene between about 70:30 and 30:70;
   iii. X represents the residue of a multi-functional coupling agent;
   iv. the weight percent of A blocks is between about 15% and about 35%;
   v. the relative amounts of copolymers IV, III, II, and I are from 0 to 20 weight percent IV, from 0 to 80 weight percent III, from 0 to 80 weight percent II and from 10 to 65 weight percent I, where the total of I, I, III and IV equals 100 weight percent.

One advantage for solvent sprayable adhesives is that the rate of evaporation for solvent based adhesives can be greater than water based adhesives, thus achieving shorter assembly time. Also, solvent sprayable adhesives can be supplied in canisters thus providing a convenient portable size. As shown in the examples which follow, the use of linear S-I/B-S block copolymers results in performance improvements in the adhesive formulations, and the use of radial S-I/B-S block copolymers aids in the reduction of viscosity, therefore opening up an opportunity for wider formulating latitude. In particular, S-I/B-S block copolymers are soluble in tertiary-butyl acetate (“tBAc”). TBAc is a non-HAP, VOC exempt solvent in most US states. Also, the S-I/B-S block copolymer solubility parameter is higher compared to SIS block copolymers. This allows a higher acetone solvent content, which is VOC exempt and lower cost. Contact adhesives with S-I/B-S block copolymers develop strength faster thus allowing shorter bond time compared to SIS block copolymers.

### DETAILED DESCRIPTION OF THE PREFERRED EMBODIMENTS

### A. Block Copolymers with Mixed Isoprene/Butadiene Midblocks

The block copolymers used in the present invention are made by a process which includes a step of reacting a living lithium-terminated polymer having the formula P-Li where P is a copolymer chain containing one block of a random isoprene/1,3-butadiene copolymer and one block of a mono alkenyl arene having 8 to 18 carbon atoms with the multi functional coupling agent. As used in the claims and specification, the term “butadiene” refers to 1,3-butadiene.

Mono alkenyl arenes that can be polymerized together with the dienes to form the polymer chain P are preferably those selected from the group of styrene, the methylstyrenes, particularly 3-methylstyrene, the propylstyrenes, particularly 4-propylstyrene, the butyl styrenes, particularly p-t-butylstyrene, vinylnapthalene, particularly 1-vinylnapthalene, cyclohexylstyrenes, particularly 4-cyclohexylstyrene, p-tolylstyrene, and 1-vinyl-5-hexylnaphthalene.

The polymer chains P are block copolymers of butadiene/isoprene monomers and mono alkenyl-substituted aromatic monomers. The presently preferred monomers are isoprene, 1,3-butadiene and styrene. The presently preferred polymer chains P are those where the conjugated dienes are present in a major amount and the mono vinyl-substituted arenes are present in a minor amount. It is preferred that the mono alkenyl arene content be from about 15 to about 35 weight percent of the total block copolymer, more preferably from about 15 to about 31 weight percent.

Those polymers in which the polymer chain P has a structure A-B- so that B is attached to the coupling agent, and in which A represents a block of mono alkenyl arenes, preferably a polystyrene block, and B represents a block that confers rubbery properties to the polymer chain, such as a poly conjugated diene block—i.e. a block of isoprene and butadiene. Such a polymer exhibits properties both of an elastomer and of a thermoplastic polymer. Therefore, such polymers can be formed into articles by standard procedures known for producing articles from thermoplastic polymers while the finished article exhibits elastomeric properties.

Furthermore, specific polymers constituting preferred embodiments of this invention are those obtained by reactions and procedures disclosed in detail in the following description of a process to make these polymers.

In accordance with another embodiment of this invention, there is provided a process for making the polymers defined above which comprises a coupling reaction between a living polymer having the formula P-Li and a multi functional coupling agent, wherein Li is lithium and P is as described above.

The quantity of coupling agent employed with respect to the quantity of living polymers P-Li present depends largely upon the degree of coupling and the properties of the coupled polymers desired. Preferably the coupling agent defined above will be employed in a range of from about ½ to about ⅕ equivalents of coupling agent per mole of lithium, more preferably from about ⅓ to about ¼ equivalents of coupling agent based upon the moles of lithium present in the polymer.

As stated above, the coupling agent used in the present invention to make radial polymers is a multifunctional coupling agent, which means a coupling agent that is capable of preparing a polymer with three or more arms radiating from the coupling agent residue. Such coupling agents include, for example, silicon halides, siloxanes, esters of monohydric alcohols with carboxylic acids, and epoxidized oils, such as epoxidized soy bean oil. An example of a preferred coupling agent for radial block copolymers is glycidoxy propyl trimethoxy silane (GPTS). Star-shaped polymers are prepared with polyalkenyl coupling agents as disclosed in, for example, U.S. Pat. Nos. 3,985,830; 4,391,949; and 4,444,953; Canadian Patent Number 716,645. Suitable polyalkenyl coupling agents include divinylbenzene, and preferably m-divinylbenzene. Linear block copolymers may be made by a sequential method, or by coupling with a coupling agent such as dibromoethane or an epoxy coupling agent, such as Epon 825 or Epon 826.

The temperature at which the coupling reaction is carried out can vary over a broad range and, for convenience, often is the same as the temperature of polymerization. Although the temperature can vary broadly from about 0° to 150° C., it will preferably be within the range from about 30° C. to 100° C., more preferably about 55° C. to about 80° C.

The coupling reaction is normally carried out by simply mixing the coupling agent, neat or in solution, with the living polymer solution. The reaction period is usually quite short, and can be affected by the mixing rate in the reactor. The normal duration of the coupling reaction will be in the range of 1 minute to 1 hour. Longer coupling periods may be required at lower temperatures.

The polymer is separated from the reaction mixture by standard techniques, such as steam stripping or coagulation with a suitable non-solvent such as an alcohol or water. The coagulated or stripped polymer is then removed from the resulting medium by, e.g., countercurrent flow through a cyclone, centrifugation or extrusion. Residual solvent and other volatiles can be removed from the isolated polymer by heating, optionally under reduced pressure or in a forced airflow.

It is also important to control the molecular weight of the various blocks. Regarding the AB block copolymer composition, for each A block the desired block weights are 5,000 to about 17,000, preferably about 7,000 to about 14,000. For each B block the desired block weights are about 50,000 to about 100,000, preferably about 60,000 to about 90,000. These molecular weights are most accurately determined by light scattering measurements, and are expressed as number average molecular weights.

It is also important to control the microstructure or vinyl content of the conjugated diene in the B blocks. The term “vinyl” has been used to describe the polymer product that is made when 1,3-butadiene is polymerized via a 1,2-addition mechanism. The result is a monosubstituted olefin group pendant to the polymer backbone, a vinyl group. In the case of anionic polymerization of isoprene, insertion of the isoprene via a 3,4-addition mechanism affords a geminal dialkyl C═C moiety pendant to the polymer backbone. The effects of 3,4-addition polymerization of isoprene on the final properties of the block copolymer will be similar to those from 1,2-addition of butadiene. When referring to the use of butadiene as the conjugated diene, it is preferred that about 1 to 80 mol percent of the condensed butadiene units in the block have 1,2-vinyl configuration. Preferably, from about 4 to about 20 mol percent of the condensed butadiene units should have 1,2 configuration. When referring to the use of isoprene as the conjugate diene, it is preferred that about 4 to 20 mol percent of the condensed isoprene units in the block have 3,4-vinyl configuration. This is effectively controlled by addition of an ether, such as diethyl ether, or a diether, such as 1,2-diethoxypropane, or an amine as a microstructure modifier to the diluent. Suitable ratios of microstructure modifier to lithium are disclosed and taught in U.S. Pat. No. Re. 27,145. The polymers of this invention can be made without any microstructure modifier, thus the vinyl content will be in the low end of the aforementioned range.

It is important to control the ratio of isoprene to butadiene in order to mitigate thermal cross-linking and control raw material costs. Moreover, too much butadiene can diminish adhesive properties. The weight ratio of isoprene to butadiene is between about 70:30 and 30:70, preferably between about 65:35 and 50:50. The relative amounts of the tetra-branched (IV), tri-branched (III), di-branched (II) and linear diblock (I) species are: 0 to 20 weight percent tetra-branched IV, 0 to 80 weight percent tri-branched III, 0 to 80 weight percent di-branched II and 10 to 65 weight percent linear diblock I. For linear block copolymers, the preferred amounts are: 0 to 5 weight percent IV, 0 to 10 weight percent III, 40 to 80 weight percent II and 20 to 60 weight percent I. For radial block copolymers, the preferred amounts are: 0 to 20 weight percent IV, 80 to 30 weight percent III, 0 to 10 weight percent II and 20 to 40 weight percent I.

The block copolymer composition has a Coupling Efficiency (“CE”) of about 40 to 80 weight percent, preferably about 40 to about 75 weight percent. Coupling Efficiency is defined as the proportion of polymer chain ends which were living, P-Li, at the time the coupling agent was added that are linked via the residue of the coupling agent at the completion of the coupling reaction. In practice, Gel Permeation Chromatography (GPC) data is used to calculate the coupling efficiency for a polymer product. The sum of the areas under the GPC curve for all of the coupled species (II+III+IV) is divided by the sum of the areas under the GPC curve for all of the coupled moieties plus the area under the curve for the starting, uncoupled polymer species (I+II+III+IV). This ratio is multiplied by 100 to convert the coupling efficiency to a percentage value.

The percentage of mono alkenyl blocks (i.e., A blocks in the AB copolymer) in the block copolymer composition is desired to be about 15 to about 35 weight percent, preferably about 17 to about 31 weight percent.

### B. Contact Adhesive Compositions

The invention relates specifically to a solvent sprayable contact adhesive composition comprising the radial polymer composition, a tackifier, a solvent and an optional plasticizer. Suitable aromatic hydrocarbon resins as tackifying resins are those having a relative percentage of aromaticity (based on aromatic protons relative to the total number of protons in the molecule as determined by H-NMR) in the range of 3 to 18%, preferably in the range of 4 to 14%.

Suitable tackifier resins may be selected from the type generally referred to as mixed aliphatic/aromatic resins or so-called heat reactive hydrocarbon resins. These hydrocarbon resins have a mixed aromatic and aliphatic composition. The streams used to produce these resins contain C-9 components (indene and styrene) and various other C-5 monomers or C-5 dimers.

Examples of suitable mixed aliphatic/aromatic resins and heat reactive hydrocarbons include ESCOREZ 2101 (Exxon Chemicals); Wingtack ET and Wingtack 86 (Sartomer); Piccotac MBG 222 and 223 and HERCOTAC 205 (Eastman) (trademarks). The preferred tackifier resin is Wingtack ET, which has a light pale color, and may be used where low color formation is desirable. Though this list may not be comprehensive, to achieve tack a resin with greater than 10% aromatics is needed. Also, contact adhesives can be formulated to give non-PSA properties. In that case, a C5 hydrocarbon resin with less than 10% aromatics may be suitable. The composition according to the present invention preferably comprises from 50 to 400 parts by weight, more preferably from 100 to 300 parts by weight of a tackifying resin, per hundred parts by weight rubber (phr).

Suitable plasticizers include plasticizing oils like low aromatic content hydrocarbon oils that are paraffinic or naphthenic in character (carbon aromatic distribution ≦5%, preferably ≦2%, more preferably 0% as determined according to DIN 51378). Those products are commercially available from the Royal Dutch/Shell Group of companies, like SHELLFLEX, CATENEX, and ONDINA oils. Other oils include KAYDOL oil from Witco, or TUFFLO oils from Arco. Other plasticizers include compatible liquid tackifying resins like REGALREZ R-1018. (SHELLFLEX, CATENEX, ONDINA, KAYDOL, TUFFLO and REGALREZ are trademarks).

Other plasticizers may also be added, like olefin oligomers; low molecular weight polymers (≦30,000 g/mol) like liquid polybutene, liquid polyisoprene copolymers, liquid styrene/isoprene copolymers or liquid hydrogenated styrene/conjugated diene copolymers; vegetable oils and their derivatives; or paraffin and microcrystalline waxes.

The composition according to the present invention may, but need not, contain a plasticizer. If it does, then the composition comprises up to 200 parts by weight, preferably 5 to 150 parts by weight, more preferably 10 to 130 parts by weight of a plasticizer. Indeed, each block copolymer (i) may be pre-blended with a small amount of plasticizer by the manufacturer of said copolymer.

In the present formulations, one of the solvents is a VOC exempt solvent. Some solvents are considered by the government regulators to be VOC exempt because they have little tendency to form ozone. Acetone and p-chlorobenzotriflouride (PCBTF) are exempt solvents. T-butyl acetate is currently exempt in all but 3 states in the United States, with additional exemptions expected later. Acetone is an inexpensive solvent, but its use is limited by its fast evaporation rate, its low flash point and its high solubility parameter. PCBTF (KESSCHEM 100 from Kessler Chemical) has fairly good evaporation characteristics but it is expensive and has high density. TBAc is a very attractive solvent because it has the right evaporation characteristics, it is reasonably priced and it has density typical of common solvents. Regulations for Consumer Products also have a category called Low Vapor Pressure (LVP) solvents, which are considered to be VOC exempt. Solvents which have >12 carbon atoms fall into this category. Conosol C-200 (from Penreco), which is a mixture of C₁₂-C₁₆ isoparaffin/cycloparaffin molecules, is an example of an LVP solvent.

Preferred VOC exempt solvents are acetone, p-chlorobenzotrifluoride and t-butyl acetate. The type and amount of each solvent can be adjusted to obtain the appropriate level of solids, which will not only meet VOC requirements, but also will have the right drying characteristics to give a high quality, smooth, pinhole-free, stress-free coating. Starting amounts to consider are about 75 to about 125 parts by weight of hydrocarbon solvent and about 75 to about 125 parts by weight of VOC exempt solvent. In a preferred embodiment, the solvent is a mixture of acetone and tBAc.

Other rubber components may be incorporated into the adhesive compositions according to the present invention. It is also known in the art that various other components can be added to modify the tack, the odor, and the color of the adhesives. Antioxidants and other stabilizing ingredients can also be added to protect the adhesive from degradation induced by heat, light and processing or during storage. Several types of antioxidants can be used, either primary antioxidants like hindered phenols or secondary antioxidants like phosphite derivatives or blends thereof. Examples of commercially available antioxidants are IRGANOX 565 from Ciba-Geigy (2.4-bis-(n-octylthio)-6-(4-hydroxy-3,5-di-tertiarybutyl anilino)-1,3,5-triazine), IRGANOX 1010 from Ciba-Geigy (tetrakis-ethylene-(3,5-di-tertiary-butyl-4-hydroxy-hydrocinnamate)methane) and POLYGARD HR from Uniroyal (tris-(2,4-di-tertiary-butyl-phenyl)phosphite). Other antioxidants developed to protect the gelling of the polybutadiene segments can also be use, like the SUMILIZER GS from Sumitomo (2[1-(2-hydroxy-3,5-di-ter-pentylphenyl)ethyl)]-4,6-di-tert-pentylphenylacrylate); SUMILIZER T-PD from Sumitomo (pentaerythrythyltetrakis(3-dodecylthiopropionate)); or mixtures thereof. (IRGANOX, POLYGARD and SUMILIZER are trademarks).

No particular limitation is imposed on the preparation process of the adhesive composition. Therefore, there may be used any process such as a mechanically mixing process making use of rolls, a Banbury mixer or a Dalton kneader, a hot-melt process characterized in that heating and mixing are conducted by using a melting kettle equipped with a stirrer, like a high shear Z-blade mixer or a single- or twin-screw extruder, or a solvent process in which the compounding components are poured in a suitable solvent and stirred, thereby obtaining an intimate solution of the contact adhesive composition. Other processes may be used to mix and apply the adhesive composition.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

Tests were run regarding room temperature solution viscosity on formulated solutions, SAFT on Mylar to Mylar, ash wood to ash wood, melamine to ash wood, 180° peel on Mylar to steel, canvas to canvas, canvas to polyurethane foam, and lap shear - ash wood to ash wood. Except for solution viscosity, each test was replicated three times. Solution viscosity was run once. Where canvas was used, it was soaked in a primer solution (shown below) and dried for one week in a hood prior to applying the adhesive for testing.

| Primer Solution | Percent weight |
|---|---|
| KRATON G1652 polymer | 10 |
| Picco 6100 end block | 25 |
| resin | |
| Irganox 1010 antioxidant | 1 |
| Toluene | 65 |

Kraton® G 1652 polymer is a selectively hydrogenated S-EB-S block copolymer available from Kraton Polymers. Picco 6100 resin is a hydrocarbon resin produced from aromatic monomers, available from Eastman Chemical.

### Formulations:

All formulations had a thickness of about 2.5 to 3 mils. All canvas to non-brittle polyurethane (PU) foams failed the same regardless of polymers(s) used. PU foams tore rather than failing at the adhesive bond line. All films had a tacky feel.

The first set of formulations was based on polymers SIS D1161P, S-I/B-S MD6455BT and blends of the two. S-I-S D1161P is a styrene/isoprene/styrene block copolymer having a linear structure and a styrene content of 15.5% weight. MD6455BT has styrene end blocks and mixed isoprene/butadiene mid blocks, having a linear structure and a styrene content of 19.0% weight. D1161P and MD6455BT are compared below in Table 1:

TABLE 1
Kraton MD6455 Product Characteristics

Polymer

| | D1161P | MD6455BT |
|---|---|---|
| Polystyrene, % w | 15.5 | 19.0 |
| Main Peak MW, M | 222 | 175 |
| Polystyrene block MW, M | 11 | 11 |
| Coupling Efficiency, % | 81 | 73 |
| Vis at 25% w in toluene at | 1200 | 1210 |
| 25 C., cps | | |
| Melt Flow, 200 C./5 kg | 13.5 | 13.7 |
| Bd/l ratio | 0/100 | 40/60 |
| Structure | Linear | Linear |

The ratio of polymer blends was 2:1, 1: 1, and 1:2. The solvent used was t-butylacetate (“tBAc”). Resins used were Piccotac 1095 and Piccotac 7590. Piccotac 1095 is an aliphatic C5 hydrocarbon resin, and Piccotac 7590 is an aromatic-modified, aliphatic hydrocarbon resin. The stabilizer was Irganox 1010 hindered phenolic, and was used for all formulations. Because film surface was uneven when only t-butyl acetate was used, a small amount of toluene was used to slow down evaporation rate and give a smooth casted film surface for testing. The results are shown below in Table 2.

TABLE 2
Adhesive formulations with D1161, MD6455, and blends of the two

| | Formulation #, parts by weight | | | | |
|---|---|---|---|---|---|
| | 1 | 2 | 3 | 4 | 5 |
| D1161P | 50 | | 37.5 | 25 | 12.5 |
| MD6455BT | | 50 | 12.5 | 25 | 37.5 |
| PICCOTAC | 50 | | | | |
| 1095 | | | | | |
| PICCOTAC | | 50 | 50 | 50 | 50 |
| 7590 | | | | | |
| IRGANOX 1010 | 1 | 1 | 1 | 1 | 1 |
| tBAc | 160 | 160 | 160 | 160 | 160 |

SAFT, ° C.

| | | | | | |
|---|---|---|---|---|---|
| Mylar to Mylar | 75.35 | 57.34 | 61.67 | 62.4 | 68.89 |
| Failure mode | cohesive | cohesive | cohesive | cohesive | cohesive |
| Ash wood to | 55.82 | 61.89 | 77.88 | 54.19 | 62.51 |
| Ash wood | | | | | |
| Failure mode | cohesive | cohesive | cohesive | cohesive | cohesive |
| Melamine to | 75.38 | 72.12 | 64.79 | 70.62 | 69.11 |
| Ash wood | | | | | |
| Failure mode | cohesive | cohesive | cohesive | cohesive | cohesive |

Instron - 180 peel, lbs per inch (lbf/in)

| | | | | | |
|---|---|---|---|---|---|
| Mylar to Steel | 2.49 | 2.17 | 2.55 | 2.28 | 3.20 |
| Failure mode | adhesive | cohesive | cohesive | adhesive | cohesive |
| Canvas to | 4.31 | 2.82 | 6.47 | 7.36 | 10.95 |
| Canvas | | | | | |
| Failure mode | cohesive | cohesive | cohesive | cohesive | cohesive |

Lap shear, wood to wood, lbs per sq inch (psi)

| | | | | | |
|---|---|---|---|---|---|
| Instron- Mean | 31.405 | 66.2 | 8.255 | 6.56 | 4.01 |
| Value | | | | | |
| Standard | 10.585 | 4.74 | 4.395 | 1.42422 | 1.0044 |
| Deviation | | | | | |
| Failure mode | cohesive | cohesive | cohesive | cohesive | cohesive |

Brookfield Solution Viscosity at 25° C. in cPs

| | | | | | |
|---|---|---|---|---|---|
| t-butylacetate | 1,380 | 1,340 | 1,470 | 1,390 | 1,340 |
| solvent | | | | | |

MD6455 S-I/B-S block copolymers with Piccotac 7590 resin shows lap shear wood-to-wood properties significantly better than D1161 with Piccotac 1095. However blends of the two polymers at any ratio with Piccotac 7590 did not do as well. For other tests, the blends either were similar in performance or results did not change consistently with change in polymer blend ratios.

### Example 2

A second set of formulations were based on S-I-S D1113P, S-I/B-S MD6465 and blends of the two. D1113 is an S-I-S block copolymer. MD6465 is a mixed mid block copolymer as claimed herein, having a lower coupling efficiency. The tackifying resin used was Piccotac 7590 for all formulations. Solvent and stabilizer remained unchanged. Table 3 below compares the polymer characteristics of D1113 and MD6465.

TABLE 3
Polymer properties

| Product Characteristics | D1113P | MD6465BT |
|---|---|---|
| Main Peak MW, M | 245 | 229 |
| Coupling Efficiency, % | 44 | 42 |
| Polystyrene, % w | 16.2 | 17.8 |
| Vis at 25% w in toluene at | 680 | TBD |
| 25 C., cps | | |
| Bd/l ratio | 0/100 | 40/60 |
| Polystyrene block MW, M | 12.6 | 12.4 |
| Structure | Linear | Linear |

TABLE 4
Adhesive formulations with SIS D1113, MD6465, and blends of the two

| | Formulation #, parts by weight | | | | |
|---|---|---|---|---|---|
| | 1 | 2 | 3 | 4 | 5 |
| MD6455 | | | 37.5 | 25 | 12.5 |
| D1113 | 50 | | | | |
| MD6465 | | 50 | 12.5 | 25 | 37.5 |
| PICCOTAC | 50 | 50 | 50 | 50 | 50 |
| 7590 | | | | | |
| IRGANOX | 1 | 1 | 1 | 1 | 1 |
| 1010 | | | | | |
| t-butyl acetate | 160 | 160 | 160 | 160 | 160 |
| solvent | | | | | |

SAFT, ° C.

| | | | | | |
|---|---|---|---|---|---|
| Mylar to Mylar | 74.83 | 86.02 | 87.41 | 85.58 | 90.27 |
| Failure mode | cohesive | cohesive | cohesive | cohesive | cohesive |
| Ash wood to | 53.35 | 45.50 | 44.47 | 50.12 | 52.98 |
| Ash wood | | | | | |
| Failure mode | cohesive | cohesive | cohesive | cohesive | cohesive |
| Melamine to | 64.16 | 52.98 | 60.64 | 53.6 | 53.82 |
| Ash wood | | | | | |
| Failure mode | cohesive | cohesive | cohesive | cohesive | cohesive |

Instron - 180 peel, (lbf/in)

| | | | | | |
|---|---|---|---|---|---|
| Mylar to Steel | 5.25 | 5.44 | 3.4 | 4.43 | 4.76 |
| Failure mode | adhesive | adhesive | adhesive | adhesive | adhesive |
| Canvas to | 7.29 | 12.9 | 10.15 | 12.57 | 19.00 |
| Canvas | | | | | |
| Failure mode | cohesive | cohesive | cohesive | cohesive | cohesive |

Lap shear - wood to wood, at break, (psi)

| | | | | | |
|---|---|---|---|---|---|
| Instron-Mean | 1.24 | 4.46 | 3.18 | 2.11 | 2.56 |
| Value | | | | | |
| Standard | 1.4316 | 2.43299 | 0.60456 | 0.40423 | 1.90974 |
| Deviation | | | | | |
| Failure mode | cohesive | cohesive | cohesive | cohesive | cohesive |

Brookfield Solution Viscosity at 25° C. in cPs

| | | | | | |
|---|---|---|---|---|---|
| t-butylacetate | 904 | 1,610 | 1,370 | 1,440 | 1,530 |
| solvent | | | | | |

SAFT (Mylar to Mylar), Peel (Canvas to Canvas) and Lap Shear (wood to wood) results with MD6465 polymer or blends with D11 13 were better than formulations with only D1113 as the polymer. All formulations included Piccotac 7590 resin. Piccotac 7590 is about 20% aromatic C5. The solution viscosity is higher with formulations using MD6465 due to the butadiene.

### Example 3

Third and fourth sets of formulations were based on S-B-S D1102 or D1155BJ and blends containing MD6460BT. Resins used were Picco 6100 hydrocarbon resin and Wingtack 86 aromatic modified resin. Solvent and stabilizer remained unchanged. Note the adhesives were tacky when films were dry. This may be an indication that formulation may not be optimized for non-PSA. Table 5 lists product summary for S-B-S and S-I/B-S polymers. Table 6 and 7 show formulations and test results for S-B-S and S-I/B-S polymers.

TABLE 5
MD6460BT Product Characteristics

| Product Characteristics | D1102K | D1155BJ | MD6460BT |
|---|---|---|---|
| Main Peak MW, M | 120 | 103 | 175 |
| Coupling Efficiency, % | 83.0 | <1 | 71 |
| Polystyrene, % w | 28.4 | 40 | 30 |
| Vis at 25% w in toluene at | 1100 | 700 | 540 |
| 25 C., cps | | | |
| Bd/l ratio | 100/0 | 100/0 | 40/60 |
| Polystyrene block MW, M | 10.2 | 9.5 | 13.2 |
| Melt Flow, 200 C./5 kg | 14 | 11 | 9 |
| Structure | Linear | Linear | 3 & 4 arm |
| | | | radial |
| | | | (predominately |
| | | | 3 arm) |

TABLE 6
Results of D1102 S-B-S, MD6460 S-I/B-S, and blends for contact adhesive

| | Formulation, parts by weight | | | | |
|---|---|---|---|---|---|
| | 1 | 2 | 3 | 4 | 5 |
| D1102K | 50 | | 37.5 | 25 | 12.5 |
| MD6460BT | | 50 | 12.5 | 25 | 37.5 |
| WINGTACK 86 | 25 | 25 | 25 | 25 | 25 |
| PICCO 6100 | 25 | 25 | 25 | 25 | 25 |
| IRGANOX 1010 | 1 | 1 | 1 | 1 | 1 |
| tBAc | 150 | 150 | 150 | 150 | 150 |

SAFT, ° C.

| | | | | | |
|---|---|---|---|---|---|
| Mylar to Mylar | 66.4 | 64.02 | 67.32 | 61.56 | 65.52 |
| Failure mode | cohesive | cohesive | cohesive | cohesive | cohesive |
| Ash wood to Ash wood | 62.62 | 70.25 | 63.76 | 63.47 | 71.2 |
| Failure mode | cohesive | cohesive | cohesive | cohesive | cohesive |
| Melamine to Ash wood | 68.6 | 78.83 | 68.82 | 68.86 | 73.77 |
| Failure mode | cohesive | cohesive | cohesive | cohesive | cohesive |

Instron - 180 peel, lbf/in

| | | | | | |
|---|---|---|---|---|---|
| Mylar to Steel | 3.33 | 4.62 | 3.43 | 3.57 | 4.01 |
| Failure mode | adhesive | cohesive | cohesive | cohesive | adhesive |
| Canvas to Canvas | 16.79 | 9.47 | 15.48 | 15.35 | 14.82 |
| Failure mode | cohesive | cohesive | cohesive | cohesive | cohesive |

Lap shear, wood to wood, psi

| | | | | | |
|---|---|---|---|---|---|
| Instron- Mean Value | 11.98 | 10.36 | 17.235 | 7.31 | 12.55 |
| Standard Deviation | 2.65309 | 2.43883 | 0.195 | 1.22 | 0.94865 |
| Failure mode | cohesive | cohesive | cohesive | cohesive | cohesive |

Brookfield Solution Viscosity, 25° C., cPs

| | | | | | |
|---|---|---|---|---|---|
| t-butylacetate solvent | 2,160 | 855 | 1,770 | 1,400 | 1,080 |

TABLE 7
Results of D1155 high styrene S-B-S, MD6460 S-I/B-S, and blends for contact adhesive

| | Formulation, parts by weight | | | | |
|---|---|---|---|---|---|
| | 1 | 2 | 3 | 4 | 5 |
| MD6460BT | | 50 | 12.5 | 25 | 37.5 |
| D1155BJ | 50 | | 37.5 | 25 | 12.5 |
| WINGTACK 86 | 25 | 25 | 25 | 25 | 25 |
| PICCO 6100 | 25 | 25 | 25 | 25 | 25 |
| IRGANOX 1010 | 1 | 1 | 1 | 1 | 1 |
| tBAc | 150 | 150 | 150 | 150 | 150 |

SAFT, ° C.

| | | | | | |
|---|---|---|---|---|---|
| Mylar to Mylar | 82.72 | 68.31 | 70.32 | 61.01 | 65.41 |
| Failure mode | cohesive | cohesive | cohesive | cohesive | cohesive |
| Ash wood to Ash wood | 58.08 | 63.25 | 66.25 | 56.76 | 58.74 |
| Failure mode | cohesive | cohesive | cohesive | cohesive | cohesive |
| Melamine to Ash wood | 71.72 | 72.08 | 65.34 | 65.01 | 71.68 |
| Failure mode | cohesive | cohesive | cohesive | cohesive | cohesive |

Instron - 180 peel, lbf/in

| | | | | | |
|---|---|---|---|---|---|
| Mylar to Steel | 3.5 | 4.16 | 4.03 | 4.73 | 4.59 |
| Failure mode | adhesive | adhesive | adhesive | adhesive | adhesive |
| Canvas to Canvas | 13.3 | 14.09 | 12.66 | 12.64 | 13.42 |
| Failure mode | cohesive | cohesive | cohesive | cohesive | cohesive |

Lap Shear - wood to wood, psi

| | | | | | |
|---|---|---|---|---|---|
| Instron- Mean Value | 11.4 | 13.96 | 12.41 | 10.81 | 11.47 |
| Standard Deviation | 1.91432 | 1.81 | 13.99169 | 2.47809 | 0.89232 |
| Failure mode | cohesive | cohesive | cohesive | cohesive | cohesive |

Brookfield Solution Viscosity, 25 C., cPs

| | | | | | |
|---|---|---|---|---|---|
| t-butylacetate solvent | 1,380 | 858 | 1,200 | 1,080 | 935 |

The most significant difference in both Table 6 and 7 is the lower solution viscosity where Kraton MD6460BT polymer is used as a single polymer or with blends of S-B-S D1102K or S-B-S D1155BJ. This lower viscosity may allow for a much wider formulating latitude.

What is claimed is:

1. A solvent sprayable contact adhesive composition comprising (i) one or more block copolymers, (ii) one or more tackifying resins, (iii) one or more solvents and (iii) optionally, one or more plasticizers, wherein at least one of the block copolymers is a block copolymer composition comprising:
a. a tetra-branched block copolymer (IV) represented by the general formula (A-B)₄X;
b. a tri-branched block copolymer (III) represented by the general formula (A-B)₃X;
c. a di-branched block copolymer (II) represented by the general formula (A-B)₂X; and
d. a linear diblock copolymer (I) represented by the general formula A-B; where:
i. A represents a polymer block of a mono alkenyl arene;
ii. B represents a polymer block of a mixture of isoprene and 1,3-butadiene in a weight ratio of isoprene to butadiene between about 70:30 and 30:70;
iii. X represents the residue of a multi-functional coupling agent;
iv. the weight percent of A blocks is between about 15% and about 35%;
v. the relative amounts of copolymers IV, III, II, and I are from 0 to 20 weight percent IV, from 0 to 80 weight percent III, from 0 to 80 weight percent II and from 10 to 65 weight percent I, where the total of I, II, III and IV equals 100 weight percent.

2. The adhesive composition of claim 1 where said adhesive composition comprises 100 parts by weight of said block copolymer composition, 50 to 400 parts by weight of said tackifier resin, and 100 to 600 parts by weight of a VOC-exempt solvent.

3. The adhesive composition of claim 2 also containing 5 to 150 parts by weight of a plasticizer.

4. The adhesive composition of claim 2 wherein said mono alkenyl arene is styrene.

5. The adhesive composition of claim 4 wherein said block B has a glass transition temperature (Tg) less than about −50° C. as determined according to ASTM E-1356-98.

6. The adhesive composition of claim 5 wherein each block A has a weight average molecular weight of about 5,000 to about 17,000 and each B block has a weight average molecular weight of about 50,000 to about 100,000.

7. The adhesive composition of claim 6 wherein said block copolymer is a linear block copolymer.

8. The adhesive composition of claim 2 wherein said solvent is a VOC-exempt solvent selected from the group consisting of acetone, p-chlorobenzotrifluoride and t-butyl acetate.

9. The adhesive composition of claim 8 wherein said VOC-exempt solvent is t-butyl acetate.

10. The adhesive composition of claim 2 wherein the solvent is a mixture of acetone and t-butyl acetate.

11. The adhesive composition of claim 10 wherein said tackifying resin has a relative percentage of aromaticity (based on aromatic protons relative to the total number of protons in the molecule as determined by H-NMR) in the range of 3 to 35% by weight.

12. The adhesive composition of claim 11 wherein said tackifying resin is an aromatic modified, aliphatic hydrocarbon resin.

13. The adhesive composition of claim 6 wherein said block copolymer is a radial block copolymer.

14. The adhesive composition of claim 13 wherein the relative amounts of copolymers IV, III, II, and I are from 0 to 20 weight percent IV, from 30 to 80 weight percent III, from 0 to 10 weight percent II and from 20 to 40 weight percent I, where the total of I, II, III and IV equals 100 weight percent.

15. The adhesive composition of claim 7 wherein the relative amounts of copolymers IV, III, II, and I are from 0 to 5 weight percent IV, from 0 to 10 weight percent III, from 40 to 80 weight percent II and from 20 to 60 weight percent I, where the total of I, II, III and IV equals 100 weight percent.
